(19) United States
(12) Patent Application Publication
(10) Pub. No.: US 2026/0312131 A1
(43) Pub. Date: Oct. 8, 2026

(54) ELECTROLYTE COMPOSITION AND BATTERY

(71) Applicants: SUMITOMO CHEMICAL COMPANY, LIMITED, Tokyo (JP); Kyoto University, Kyoto (JP)

(72) Inventors: Hideto NAKAJIMA, Ehime (JP); Makoto OUCHI, Kyoto (JP)

(21) Appl. No.: 19/480,575

(22) PCT Filed: May 2, 2024
(86) PCT No.: PCT/JP2024/016894

§ 371 Date: Oct. 31, 2025

(30) Foreign Application Priority Data
May 8, 2023 (JP) 2023-076613

(51) Int. Cl. H01M 10/0565

(52) U.S. Cl. CPC H01M 10/0565; H01M 2300/0082

(57) ABSTRACT

The present disclosure provides an electrolyte composition including a polymer having an ability to conduct alkali metal ions and an organic solvent, wherein an overall donor number represented by the following formula (I) of the organic solvent included in the electrolyte composition is 16.5 or more.

$$\begin{matrix}[ Formula 1 ] & \\ DN = {\sum }_{i = 1}^{n} ( DNi ) \times ( fi ) & ( 1 )\end{matrix}$$

(wherein n is a total number of organic solvents included in the electrolyte composition and is 1 or more, DNi is a donor number of an i-th organic solvent, and fi is a mass fraction of the i-th organic solvent).

### TECHNICAL FIELD

The present disclosure relates to an electrolyte composition and a battery.

### BACKGROUND ART

Batteries that perform charging and discharging through the movement of metal ions between a positive electrode and a negative electrode, such as lithium ion batteries, have been actively researched due to their high capacity. As electrolytes for lithium ion batteries and the like, solutions of lithium salts containing an organic solvent or an ionic liquid are known. On the other hand, from the viewpoint of safety and processability, research on solid electrolytes, polymer electrolytes, and the like has been advanced (Patent Literature 1). In addition to lithium ion batteries, research is also being advanced on batteries using other alkali ions that are more abundant than lithium, such as sodium and potassium.

### CITATION LIST

### Patent Literature

Patent Literature 1: Japanese Unexamined Patent Publication No. 2001-176556

### SUMMARY OF INVENTION

### Technical Problem

However, polymer electrolytes still have room for improvement in terms of ion conductivity.

The present disclosure has been made in view of the above circumstances, and an object thereof is to provide an electrolyte composition with high ion conductivity and a battery using the same.

### Solution to Problem

The present disclosure provides, for example, the following [1] to [8]

[1]

An electrolyte composition including a polymer having an ability to conduct alkali metal ions and an organic solvent, wherein
an overall donor number of the organic solvent included in the electrolyte composition is 16.5 or more.

$$\begin{matrix}[ Formula 1 ] & \\ DN = {\sum }_{i = 1}^{n} ( DNi ) \times ( fi ) & ( 1 )\end{matrix}$$

(wherein n is a total number of organic solvents included in the electrolyte composition and is 1 or more, DNi is a donor number of an i-th organic solvent, and fi is a mass fraction of the i-th organic solvent).
   [2]

An electrolyte composition including a polymer having an ability to conduct alkali metal ions and an organic solvent, wherein
a proportion of an organic solvent having a donor number of 17 or more among the organic solvent included in the electrolyte composition is 10 mass % or more based on a total amount of the organic solvent.
   [3]

The electrolyte composition of [1] or [2], wherein the organic solvent includes one or more organic solvents selected from the group consisting of ether-based solvents, phosphate ester-based solvents, carbonate-based solvents, fluorine-based solvents, and nitrile-based solvents.

[4]

The electrolyte composition of any one of [1] to [3], further including an anion receptor.

[5]

The electrolyte composition of [4], wherein the anion receptor is a compound having Lewis acidity and including a group 13 element.

[6]

The electrolyte composition of any one of [1] to [5], wherein the polymer having an ability to conduct alkali metal ions includes one or more groups selected from the group consisting of alkali-metallized sulfonylimide groups, alkali-metallized sulfonic acid groups, alkali-metallized carboxylic acid groups, and alkali-metallized phenol groups.

[7]

The electrolyte composition of any one of [1] to [6], further including an alkali metal salt.

[8]

A battery including the electrolyte composition of any one of [1] to [7].

### Advantageous Effects of Invention

According to the present invention, it is possible to provide an electrolyte composition with high ion conductivity and a battery using the same.

### DESCRIPTION OF EMBODIMENTS

The electrolyte composition of the present embodiment includes a polymer having an ability to conduct alkali metal ions and an organic solvent. The electrolyte composition satisfies at least one of the following conditions (1) to (3), and may satisfy at least one of the conditions (1) and (2).
(1) An overall donor number of the organic solvent included in the electrolyte composition is 16.5 or more.
(2) A proportion of an organic solvent having a donor number of 17 or more among the organic solvent included in the electrolyte composition is 10 mass % or more based on a total amount of the organic solvent.
(3) A content of an organic solvent having a donor number of 17 or more is 5 mass % or more based on a total amount of the electrolyte composition.

The donor number in this specification means Gutmann's donor number (DN). Specifically, the donor number may be defined as (heat of reaction −ΔH (kcal/mol)) between a Lewis base (organic solvent) and SbCl₅, which is a reference Lewis acid. Details about such a donor number are described in, for example, Hansen Solubility Parameters 50th anniversary conference, preprint 2017 PP. 22-36 (2017), V. Gutmann, “The Donor-Acceptor Approach to Molecular Interactions”, Plenum, New York, 1978, and the like. In this case, the measurement of the heat of reaction may be performed on a very diluted reactant in a 1,2-dichloroethane solution.

Here, the “overall donor number of the organic solvent included in the electrolyte composition” is represented by the following formula (I). In the following formula, DN on the left side refers to the “overall donor number of the organic solvent included in the electrolyte composition”. n is the total number of organic solvents included in the electrolyte composition and is 1 or more. DNi is the donor number of the i-th organic solvent, and fi is the mass fraction of the i-th organic solvent. i=1, 2, 3, . . . , n, and the sum of fi from i=1 ton is 1. n may be 2 or more.

$$\begin{matrix}[ Formula 2 ] & \\ DN = {\sum }_{i = 1}^{n} ( DNi ) \times ( fi ) & ( 1 )\end{matrix}$$

In other words, the organic solvent does not have to have a single composition and may be a mixed solvent including a plurality of organic solvents, and in this case, the weighted average of the donor numbers of the respective solvents is taken as the overall donor number. That is, the term “overall donor number of the organic solvent included in the electrolyte composition” refers to the donor number of the organic solvent when the electrolyte composition includes only one type of organic solvent, and refers to the weighted average of the donor numbers over all the organic solvents included in the electrolyte composition when the electrolyte composition includes a plurality of types of organic solvents.

The electrolyte composition of the present embodiment includes an organic solvent so as to satisfy at least one of the above conditions (1) to (3). In this case, an organic solvent with a large donor number interacts with alkali metal ions, for example, by forming a coordination bond, and can relatively weaken the interaction between the alkali metal ions and their counter anions (for example, anionic functional groups possessed by the polymer, etc.), and can enhance the conductivity of alkali metal ions in the electrolyte composition when a voltage is applied. An organic solvent with a small donor number has a weak interaction with cations, and the alkali metal ions (cations) in the electrolyte composition have a relatively strong interaction with counter anions (for example, anionic functional groups possessed by the polymer, etc.). If the counter anions are fixed to the polymer chain or are bulky, the mobility of the alkali metal ions as a whole tends to decrease, and conventional polymer electrolytes do not exhibit ion conductivity as much as can be expected. On the other hand, since the electrolyte composition of the present disclosure is formulated with an organic solvent so as to satisfy the above-mentioned conditions, it is superior in ion conductivity compared to a formulation of an organic solvent that does not satisfy the above-mentioned conditions.

Examples of the organic solvent included in the electrolyte composition include aprotic solvents. The organic solvent may include only an organic solvent with a donor number of 16.5 or more, but may include both an organic solvent with a donor number of 16.5 or more and an organic solvent with a donor number of less than 16.5. The organic solvent may include only an organic solvent with a donor number of 17 or more, or may include both an organic solvent with a donor number of 17 or more and an organic solvent with a donor number of less than 17.

The organic solvent does not have to be a liquid at room temperature, but may be a liquid (that is, a solvent) at the time of use, and may have a melting point of 60° C. or less, for example.

The organic solvent may include one or more organic solvents selected from the group consisting of ether-based solvents, phosphate ester-based solvents, carbonate-based solvents, fluorine-based solvents, and nitrile-based solvents, may include one or more organic solvents selected from the group consisting of ether-based solvents, phosphate ester-based solvents, carbonate-based solvents, and fluorine-based solvents, and may include a phosphate ester.

Examples of the organic solvent having a donor number of 17 or more include solvents having an amino group (amine-based solvents), solvents having an amide bond (amide-based solvents), alcohols, solvents having an ether bond (—O—) (ether-based solvents), solvents having a sulfide bond (—S—) (sulfide-based solvents), phosphate esters, phosphoramides, ester-based solvents, nitrogen-containing aromatic compounds (compounds containing nitrogen as a ring member of an aromatic ring, which may be either a monocyclic system or a condensed ring system), urea compounds, solvents having a sulfoxide group (sulfoxide-based solvents), ketones, solvents having a carbonate group (carbonate-based solvents), and solvents having a nitrile group (nitrile-based solvents). One or two or more kinds of organic solvents having a donor number of 17 or more can be used.

Examples of the amine-based solvent having a donor number of 17 or more include triethylamine, 2-methyl-2-propanamine, ethylamine, piperidine, aniline, N-methylaniline, and the like. The amine-based solvent may have at least one of a primary amino group, a secondary amino group, and a tertiary amino group. In addition, the amine-based solvent may have a ring such as a piperidine ring.

Examples of the amide-based solvent having a donor number of 17 or more include cyclic amide-based solvents having a ring structure containing an amide bond in the ring, such as a lactam ring, and acyclic amide-based solvents not having a ring structure containing an amide bond in the ring. Examples of the acyclic amide-based solvent include N,N-diethylacetamide, N,N-dimethylacetamide, N,N-diethylformamide, N,N-dimethylformamide, N-methylformamide, formamide, and the like. Examples of the cyclic amide-based solvent include 1,3-dimethyltetrahydropyrimidin-2 (1H)-one, N-methylpyrrolidone, 1,3-dimethyl-2-imidazolidinone, and the like.

Examples of the alcohol having a donor number of 17 or more include 2-methyl-2-butanol, 3-methyl-1-butanol, 2-methyl-1-propanol, 2-methyl-2-propanol, 2-propanol, octanol, decanol, benzyl alcohol, 2-phenylethanol, 1-propanol, ethanol, methanol, and the like.

Examples of the ether-based solvent having a donor number of 17 or more include cyclic ether-based solvents having a ring structure containing an ether bond in the ring, and chain ether-based solvents not having a ring structure containing an ether bond in the ring. Examples of the cyclic ether-based solvent include tetrahydrofuran, 2-methyltetrahydrofuran, 1,3,3-trimethyl-2-oxabicyclo[2.2.2]octane, tetrahydropyran, 1,3-dioxolane, and the like. Examples of the chain ether-based solvent include 1,2-diethoxyethane, ethoxymethoxyethane, diethyl ether, 1,2-dimethoxyethane, dibenzyl ether, dibutyl ether, diisopropyl ether, and the like.

Examples of the phosphate ester having a donor number of 17 or more include compounds represented by the following chemical formula (P).

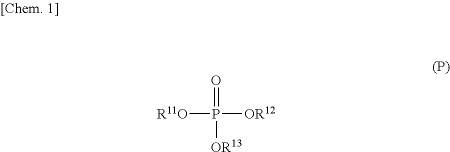

(In the formula, R¹¹ to R¹³ are each independently an organic group having 1 to 8 carbon atoms.)

Examples of R¹¹ to R¹³ in the above formula (P) include a hydrocarbon group, a monovalent group having —O— (ether bond) in the chain of a hydrocarbon group, and the like. The hydrocarbon group may be either an aliphatic hydrocarbon group or an aromatic hydrocarbon group, and may be an aliphatic hydrocarbon group. The aliphatic hydrocarbon group may be any of a chain, branched chain, or cyclic form, but may be a chain or branched chain form. The aliphatic hydrocarbon group may include an unsaturated bond, but may be a saturated aliphatic hydrocarbon group. The number of carbon atoms that R¹¹ to R¹³ in the above formula (P) have may be 1 to 6 each, may be 1 to 4 each, may be 1 to 3 each, and may be 1 or 2 each. R¹¹ to R¹³ in the above formula (P) may all be the same or different.

Examples of the phosphate ester include trimethyl phosphate (TMP), triethyl phosphate (TEP), tris(2,2,2-trifluoroethyl) phosphate (TFEP), tributyl phosphate, and the like.

Examples of the phosphoramide (phosphoramide) having a donor number of 17 or more include tripyrrolidinophosphine oxide, hexamethylphosphoramide, hexaethylphosphoramide, and the like.

Examples of the ester-based solvent having a donor number of 17 or more include tert-butyl acetate, isopropyl acetate, ethyl chloroformate, and the like.

Examples of the nitrogen-containing aromatic compound having a donor number of 17 or more include pyridine, 3-methylpyridine, 4-methylpyridine, quinoline, and the like.

Examples of the urea compound having a donor number of 17 or more include N,N,N′,N′-tetramethylurea and the like.

Examples of the sulfoxide-based solvent having a donor number of 17 or more include dibutyl sulfoxide, dimethyl sulfoxide, and the like.

Examples of the ketone having a donor number of 17 or more include cyclohexanone, cyclopentanone, and the like.

Examples of the carbonate-based solvent having a donor number of less than 17 include chain carbonates such as dimethyl carbonate, diethyl carbonate, and ethyl methyl carbonate; and cyclic carbonates such as ethylene carbonate, propylene carbonate, butylene carbonate, and vinylene carbonate.

Examples of the fluorine-based solvent include hydrofluorocarbons such as perfluorooctane; hydrofluoroethers such as methyl nonafluorobutyl ether and ethyl nonafluorobutyl ether; and hydrofluoroolefins such as 1,3,3,3-tetrafluoropropene. The donor number of the fluorine-based solvent may be less than 17.

Examples of the nitrile-based solvent include acetonitrile, succinonitrile, and the like. The donor number of the nitrile-based solvent may be less than 17.

The overall donor number of the organic solvent included in the electrolyte composition may be 17.0 or more, may be 17.5 or more, may be 17.8 or more, may be 18.0 or more, may be 18.5 or more, and may be 19.0 or more. The overall donor number of the organic solvent included in the electrolyte composition may be 40.0 or less, may be 35.0 or less, may be 30.0 or less, may be 25.0 or less, may be 23.0 or less, may be 22.0 or less, and may be 21.0 or less.

The proportion of the organic solvent having a donor number of 17 or more in the organic solvent included in the electrolyte composition may be 10 mass % or more, may be 25 mass % or more, may be 30 mass % or more, may be 35 mass % or more, and may be 40 mass % or more, based on the total amount of the organic solvent. The proportion of the organic solvent having a donor number of 17 or more among the organic solvent included in the electrolyte composition may be 90 mass % or less, may be 80 mass % or less, may be 70 mass % or less, may be 65 mass %, and may be 60 mass % or less, based on the total amount of the organic solvent. The proportion of the organic solvent having a donor number of 17 or more in the organic solvent included in the electrolyte composition may be 10 to 90 mass %, may be 25 to 80 mass %, may be 25 to 70 mass %, may be 25 to 60 mass %, may be 30 to 60 mass %, may be 35 to 65 mass %, may be 35 to 60 mass %, and may be 40 to 60 mass %, based on the total amount of the organic solvent.

The electrolyte composition of the present embodiment may include the organic solvent having a donor number of 17 or more in an amount of 5 mass % or more, may include 10 mass % or more, and may include 15 mass % or more, based on the total amount of the electrolyte composition. The electrolyte composition of the present embodiment may include the organic solvent having a donor number of 17 or more in an amount of 60 mass % or less, may include 50 mass % or more, and may include 40 mass % or less, based on the total amount of the electrolyte composition. The electrolyte composition of the present embodiment may include the organic solvent having a donor number of 17 or more in an amount of 5 to 60 mass %, or 10 to 40 mass %, based on the total amount of the electrolyte composition.

The content of the organic solvent in the electrolyte composition may be 100 to 600 parts by mass, may be 100 to 500 parts by mass, may be 150 to 450 parts by mass, may be 200 to 400 parts by mass, and may be 250 to 350 parts by mass, with respect to 100 parts by mass of the polymer having an ability to conduct alkali metal ions.

The content of the organic solvent in the electrolyte composition may be 30 to 90 mass %, may be 35 to 85 mass %, may be 40 to 80 mass %, may be 45 to 75 mass %, may be 50 to 70 mass %, and may be 60 to 70 mass %, based on the total amount of the electrolyte composition.

The electrolyte composition includes a polymer having an ability to conduct alkali metal ions (hereinafter, also simply referred to as a polymer). As the polymer, one that is excellent in alkali metal ion transference number can be used when the alkali metal ion transference number is measured for a composition including 33 mass % of the polymer and 67 mass % of a non-ionic plasticizer, or a composition including 31.9 mass % of the polymer, an alkali metal salt, and a non-ionic plasticizer as the entire remainder, at room temperature (25° C.).

The polymer may be one in which the transference number of alkali metal ions is 0.4 or more, 0.5 or more, 0.6 or more, or 0.7 or more. The alkali metal ions included in the composition may be counter cations of the anionic functional group when the polymer has an anionic functional group, or may be those added as an alkali metal salt. The polymer having an ability to conduct alkali metal ions may be a polymer having an ability to preferentially conduct alkali metal ions.

Examples of the non-ionic plasticizer used when measuring the above-mentioned alkali metal ion transference number include at least one of an organic solvent and other resins such as a fluorine-based resin.

The organic solvent used when measuring the above-mentioned alkali metal ion transference number may be an aprotic solvent. The aprotic solvent used when measuring the above-mentioned alkali metal ion transference number may be at least one selected from the group consisting of carbonate-based solvents, fluorine-based solvents, and ether-based solvents. Specific examples of the organic solvent used when measuring the above-mentioned alkali metal ion transference number may be the above-mentioned solvents for the organic solvent included in the electrolyte composition.

As the fluorine-based resin used when measuring the above-mentioned alkali metal ion transference number, a resin having a carbon chain as a main chain is preferable. The carbon chain may be one formed by radical polymerization of an ethylenically unsaturated group.

The polymer may have an anionic functional group and an alkali metal ion as a counter cation of the anionic functional group (referred to as an alkali-metallized group). The polymer may include one or more groups selected from the group consisting of an alkali-metallized sulfonylimide group, an alkali-metallized sulfonic acid group, an alkali-metallized carboxylic acid group, and an alkali-metallized phenol group, may include at least one of an alkali-metallized carboxylic acid group and an alkali-metallized phenol group, and may include an alkali-metallized carboxylic acid group.

Here, in this specification, an alkali-metallized group refers to a group in which an anionic functional group, which is a conjugate base of the acid form of the group, forms a salt with an alkali metal ion. Specifically, an alkali-metallized sulfonylimide group refers to a —SO₂—NA—SO₂— group ([—SO₂—N—SO₂]⁻A⁺ group) in which H of a sulfonylimide acid group (—SO₂—NH—SO₂— group) is substituted with an alkali metal element A. An alkali-metallized sulfonic acid group refers to a —SO₃A group ([—SO₃]⁻A⁺ group) in which H of a sulfonic acid group (—SO₃H group) is substituted with an alkali metal element A. An alkali-metallized carboxylic acid group refers to a —COOA group ([—COO]⁻A⁺ group) in which H of a carboxylic acid group (—COOH group) is substituted with an alkali metal element A. An alkali-metallized phenol group refers to an —OA group (—O⁻A⁺ group) in which H of an —OH group, which is a phenolic hydroxyl group, is substituted with an alkali metal element A.

Examples of the structure of the polymer include those having a carbon chain as a main chain, and the carbon chain may be one formed by radical addition polymerization of a monomer having an ethylenically unsaturated group.

The alkali metal element A in the alkali-metallized group may include at least one selected from the group consisting of lithium, sodium, potassium, rubidium, and cesium, may include at least one selected from the group consisting of lithium, sodium, and potassium, may include at least one of lithium and sodium, and may include lithium.

The content of one type of alkali metal element among the alkali metal elements included in the polymer may be 80 mol % or more, may be 85 mol %, and may be 90 mol %. The one type of alkali metal element may be potassium, sodium, or lithium, may be sodium or lithium, and may be lithium.

The polymer may have a structural unit (also referred to as structural unit (A)) having the anionic functional group and an alkali metal ion as a counter cation of the anionic functional group. The polymer may have one or two or more types of structural unit (A).

Examples of the structural unit (A) include a structural unit (A1) represented by the following formula (A1).

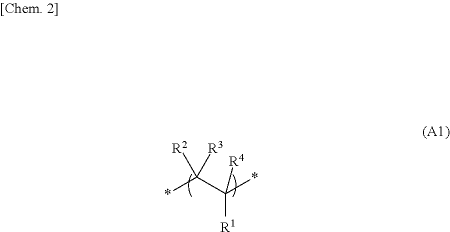

(In formula (A1), R¹ is a —COOA group or a monovalent organic group having a —COOA group, R² to R⁴ are each independently a hydrogen atom or a monovalent substituent, or one of R² and R³ is a hydrogen atom or a monovalent substituent, and the other, together with R⁴, forms a ring. * is a bonding portion of the structural unit (A1) with another structural unit.)

R¹ in the above formula (A1) may be a —COOA group itself, but may be a monovalent organic group having a —COOA group. The number of carbon atoms that the monovalent organic group has may be 1 to 20, may be 1 to 15, may be 1 to 10, may be 1 to 5, and may be 1 to 3. The monovalent organic group may have one or a plurality of —COOA groups, and may have one —COOA group. Examples of the organic group include a monovalent group which has a —COOA group as a substituent, and which is, for example, a hydrocarbon group, a group having a chemical structure formed by substituting one or more carbon atoms (methylene groups) in the hydrocarbon group with a linking group such as —O—, —S—, —C(═O)— or —C(═O)O—, a group having a heterocycle, and the like. The —COOA group is bonded to a carbon atom of another part in R¹. In addition, the monovalent group may have a substituent that substitutes a hydrogen atom bonded to a carbon atom. Examples of the substituent include an electron-withdrawing group such as a halogen atom. The hydrocarbon group is not particularly limited, and may be an aliphatic hydrocarbon group or an aromatic hydrocarbon group. The aliphatic hydrocarbon group may be any of a linear hydrocarbon group, a branched hydrocarbon group, and a cyclic hydrocarbon group. In addition, the hydrocarbon group may be either a saturated hydrocarbon group or an unsaturated hydrocarbon group. In this specification, an aromatic hydrocarbon group is a hydrocarbon group having an aromatic portion such as a benzene ring, and may have an aliphatic portion. In this specification, a cyclic hydrocarbon group is a hydrocarbon group having an aliphatic carbocyclic portion, and may have a linear or branched aliphatic portion.

R¹ in the above formula (A1) may be a group represented by —R⁹—COOA. Here, R⁹ is a divalent organic group. The number of carbon atoms that the divalent organic group has may be 1 to 19, may be 1 to 14, may be 1 to 9, may be 1 to 4, and may be 1 or 2. Examples of the divalent organic group include a monovalent group such as a hydrocarbon group, a group having a chemical structure formed by substituting one or more carbon atoms (methylene groups) in the hydrocarbon group with a linking group of —O—, —S—, —C(═O)— or —C(═O)O—, a group having a heterocycle, and the like. In addition, the divalent group may have a substituent that substitutes a hydrogen atom bonded to a carbon atom. Examples of the substituent include an electron-withdrawing group such as a halogen atom. The hydrocarbon group is not particularly limited, and may be an aliphatic hydrocarbon group or an aromatic hydrocarbon group. The aliphatic hydrocarbon group may be any of a linear hydrocarbon group, a branched hydrocarbon group, and a cyclic hydrocarbon group. In addition, the hydrocarbon group may be either a saturated hydrocarbon group or an unsaturated hydrocarbon group.

Examples of the electron-withdrawing group that R¹ in the above formula (A1) may include a halogen atom, a sulfonic acid group or a salt thereof, a sulfonic acid ester, a nitro group, a nitrile group, a carboxyl group or a salt thereof, and the like. The halogen atom may be at least one of Cl and F, and may be F.

When R⁴ in the above formula (A1) is a monovalent substituent, examples of the substituent include a monovalent organic group. The number of carbon atoms that the monovalent organic group has may be 1 to 20, may be 1 to 15, may be 1 to 10, may be 1 to 5, and may be 1 to 3. Examples of the monovalent organic group include a monovalent group which is a group having a —COOA group as a substituent, such as a hydrocarbon group, a group having a chemical structure formed by substituting one or more carbon atoms (methylene groups) in the hydrocarbon group with a linking group of —O—, —S—, —C(═O)— or —C(═O)O—, a group having a heterocycle, and the like. R⁴ in the above formula (A1) may be a hydrogen atom or a methyl group.

When R² or R³ in the above formula (A1) is a monovalent substituent, examples of the substituent include a monovalent organic group. Examples of the monovalent organic group include those exemplified as R⁴ above. At least one of R² and R³ in the above formula (A1) may be a hydrogen atom, and both R² and R³ may be hydrogen atoms.

When one of R² and R³ in the above formula (A1) forms a ring together with R⁴, the number of ring members of the ring may be 4 to 10, may be 5 to 8, and may be 5 or 6. A substituent may be bonded to the carbon atom that is a ring member.

Examples of the structural unit (A) also include a structural unit (A2) represented by the following formula (A2).

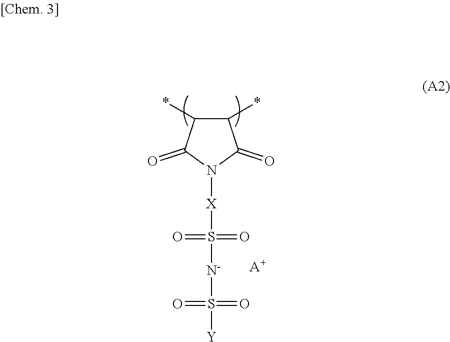

(In formula (A2), X is a divalent organic group having 1 to 20 carbon atoms, Y is a halogen atom or a monovalent organic group having 1 to 20 carbon atoms, A⁺ is an alkali metal ion, and * represents a position where the structural unit (A2) is bonded to another structural unit.)

X in the above formula (A2) is not particularly limited, and may be a hydrocarbon group or a group having a heteroatom, and may have a heterocycle. More specifically, examples of X include divalent groups such as a hydrocarbon group, and a group having a chemical structure in which one or more carbon atoms (methylene groups) in a hydrocarbon group are substituted by a linking group of —O—, —S—, —C(═O)— or —C(═O)O—. When there are a plurality of the linking groups, the linking groups are not adjacent to each other. In addition, the divalent group may have a substituent that substitutes a hydrogen atom bonded to a carbon atom. The substituent may be a monovalent substituent, and examples thereof include a halogen atom and the like. The hydrocarbon group is not particularly limited, and may be an aliphatic hydrocarbon group or an aromatic hydrocarbon group. The aliphatic hydrocarbon group may be any of a linear hydrocarbon group, a branched hydrocarbon group, and a cyclic hydrocarbon group. In addition, the hydrocarbon group may be either a saturated hydrocarbon group or an unsaturated hydrocarbon group. X in the above formula (A2) may be bonded to one or both of the nitrogen atom of the maleimide group and the sulfur atom of the sulfonyl group by a carbon atom that X has.

The number of carbon atoms that X in the above formula (A2) has may be 1 to 15, may be 2 to 10, and may be 3 to 8. X may be a group having an aromatic ring, and may be a group having an aromatic carbon ring such as a benzene ring. A substituent such as an alkyl group, a halogen atom, or an electron-withdrawing group may be bonded to a carbon atom that is a ring member of the carbon ring. The hydrocarbon group as X is preferably a phenylene group, an alkylene group having 1 to 8 carbon atoms, a polyoxyalkylene group, or a group in which a part or all of hydrogen atoms bonded to carbon atoms thereof are substituted with a halogen atom such as a fluorine atom, and more preferably a phenylene group or a substituted phenylene group substituted with an alkyl group, a halogen atom, an electron-withdrawing group, or the like. Examples of the electron-withdrawing group include a halogen atom, a sulfonic acid group or a salt thereof, a sulfonic acid ester, a nitro group, a nitrile group, and the like.

In the above formula (A2), when Y is a monovalent organic group, the organic group is not particularly limited, and may be a hydrocarbon group or a group having a heteroatom, and may have a heterocycle. More specifically, examples of Y include monovalent groups such as a hydrocarbon group, and a group having a chemical structure in which one or more carbon atoms (methylene groups) in a hydrocarbon group are substituted by a linking group of —O—, —S—, —C(═O)— or —C(═O)O—. When there are a plurality of the linking groups, the linking groups are not adjacent to each other. In addition, the monovalent group may have a substituent that substitutes a hydrogen atom bonded to a carbon atom. The substituent may be a monovalent substituent, and examples thereof include a halogen atom and the like. The hydrocarbon group is not particularly limited, and may be an aliphatic hydrocarbon group or an aromatic hydrocarbon group. The aliphatic hydrocarbon group may be any of a linear hydrocarbon group, a branched hydrocarbon group, and a cyclic hydrocarbon group. In addition, the hydrocarbon group may be either a saturated hydrocarbon group or an unsaturated hydrocarbon group.

The number of carbon atoms that Y in formula (A2) has may be 1 to 15, may be 1 to 10, may be 1 to 8, may be 1 to 5, and may be 1 to 3. The hydrocarbon group as Y is preferably a phenyl group, an alkyl group having 1 to 5 carbon atoms, or a group in which a part or all of hydrogen atoms bonded to carbon atoms of these groups are substituted with a halogen atom such as a fluorine atom, more preferably a fluorinated alkyl group having 1 to 5 carbon atoms, and still more preferably a fluorinated alkyl group having 1 to 3 carbon atoms such as a trifluoromethyl group. The fluorinated alkyl group may be a perfluorinated alkyl group.

When Y in formula (A2) is a halogen atom, the halogen atom is preferably a fluorine atom or a chlorine atom, and more preferably a fluorine atom.

As the structural unit (A), a structural unit (A3) represented by the following formula (A3) can also be mentioned.

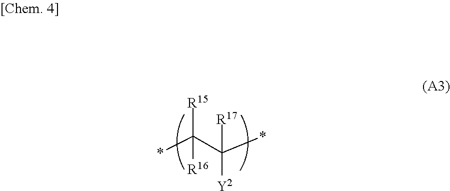

(In formula (A3), Y² is a group having an alkali-metallized phenolic hydroxyl group, or a group having an alkali-metallized sulfonic acid, and * represents a bonding position of the structural unit (A3) with another structural unit. R¹⁵ to R¹⁷ are each independently a hydrogen atom or a monovalent substituent, or R¹⁶ is a hydrogen atom or a monovalent substituent, and R¹⁵ and R¹⁷ together form a divalent substituent.)

One or more of R¹⁵ to R¹⁷ in the above formula (A3) may be a hydrogen atom, and all may be hydrogen atoms.

When R¹⁵ to R¹⁷ in the above formula (A3) are monovalent substituents, the monovalent substituent may be a monovalent organic group. The number of carbon atoms that the organic group has may be 1 to 20, may be 1 to 15, may be 1 to 10, may be 1 to 5, and may be 1 to 3. Examples of the organic group include monovalent substituents such as a hydrocarbon group, a group having a chemical structure formed by substituting one or more carbon atoms (methylene groups) in the hydrocarbon group with a linking group of —O—, —S—, —C(═O)— or —C(═O)O—, and a group having a heterocycle. In addition, the monovalent substituent may have a substituent that substitutes a hydrogen atom bonded to a carbon atom. Examples of the substituent include a halogen atom and the like. The hydrocarbon group is not particularly limited, and may be an aliphatic hydrocarbon group or an aromatic hydrocarbon group. The aliphatic hydrocarbon group may be any of a linear hydrocarbon group, a branched hydrocarbon group, and a cyclic hydrocarbon group. In addition, the hydrocarbon group may be either a saturated hydrocarbon group or an unsaturated hydrocarbon group. Examples of the hydrocarbon group include a methyl group, an ethyl group, a propyl group, a phenyl group, and the like.

With respect to R¹⁵ to R¹⁷ in the above formula (A3), the monovalent substituent may have an electron-withdrawing group, or may be an electron-withdrawing group itself. The electron-withdrawing group may be bonded to the monovalent organic group, or the monovalent organic group may be an electron-withdrawing group. Examples of the electron-withdrawing group include a halogen atom, a sulfonic acid group or a salt thereof, a sulfonic acid ester, a nitro group, a nitrile group, and the like. The halogen atom may be any of a fluorine atom, a chlorine atom, a bromine atom, and an iodine atom.

When R¹⁵ and R¹⁷ in the above formula (A3) together form a divalent organic group, the number of carbon atoms that the divalent organic group has may be 1 to 20, may be 1 to 15, may be 1 to 10, may be 1 to 5, and may be 1 to 3. Examples of the organic group include divalent substituents such as a hydrocarbon group, a group having a chemical structure formed by substituting one or more carbon atoms (methylene groups) in the hydrocarbon group with a linking group of —O—, —S—, —C(═O)— or —C(═O)O—, and a group having a heterocycle. In addition, the divalent organic group may have a substituent that substitutes a hydrogen atom bonded to a carbon atom. Examples of the substituent include a halogen atom and the like. The hydrocarbon group is not particularly limited, and may be an aliphatic hydrocarbon group or an aromatic hydrocarbon group. The aliphatic hydrocarbon group may be any of a linear hydrocarbon group, a branched hydrocarbon group, and a cyclic hydrocarbon group. In addition, the hydrocarbon group may be either a saturated hydrocarbon group or an unsaturated hydrocarbon group. Examples of the hydrocarbon group include a propylene group, a butylene group, and the like.

When Y² in the above formula (A3) is a group having a phenolic hydroxyl group, Y² may be a group represented by any of the following formulas (A21) to (A26).

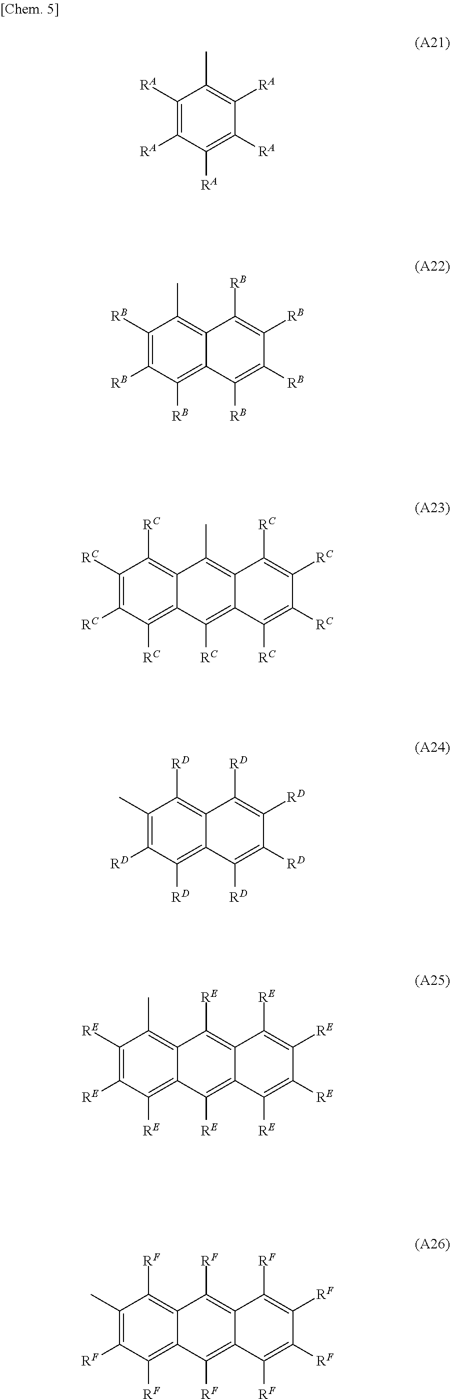

(In formula (A21), at least one of the R^{A} groups is an —OA group, and the rest are a hydrogen atom or a monovalent substituent.

In formula (A22), at least one of the R^{B} groups is an —OA group, and the rest are a hydrogen atom or a monovalent substituent.

In formula (A23), at least one of the R^{C} groups is an —OA group, and the rest are a hydrogen atom or a monovalent substituent.

In formula (A24), at least one of the R^{D} groups is an —OA group, and the rest are a hydrogen atom or a monovalent substituent.

In formula (A25), at least one of the R^{E} groups is an —OA group, and the rest are a hydrogen atom or a monovalent substituent.

In formula (A26), at least one of the R^{F} groups is an —OA group, and the rest are a hydrogen atom or a monovalent substituent.)

The group represented by the above formulas (A21) to (A26) may have 1 to 3 —OA groups, may have 1 or 2 —OA groups, and may have one —OA group.

In the above formulas (A21) to (A26), the monovalent substituent is preferably an electron-withdrawing group. Examples of the electron-withdrawing group include a halogen atom, a sulfonic acid group or a salt thereof, a sulfonic acid ester, a nitro group, a nitrile group, and the like. The halogen atom may be any of F, Cl, Br, and I.

In addition, in formulas (A21) to (A26), the monovalent substituent may be an organic group having 1 to 20 carbon atoms. The number of carbon atoms that the organic group has may be 1 to 15, may be 1 to 10, may be 1 to 5, and may be 1 to 3. Examples of the organic group include monovalent groups such as a hydrocarbon group, a group having a chemical structure formed by substituting one or more carbon atoms (methylene groups) in the hydrocarbon group with a linking group of —O—, —S—, —C(═O)— or —C(═O)O—, and a group having a heterocycle. In addition, the monovalent group may have a substituent that substitutes a hydrogen atom bonded to a carbon atom. Examples of the substituent include a halogen atom and the like. The hydrocarbon group is not particularly limited, and may be an aliphatic hydrocarbon group or an aromatic hydrocarbon group. The aliphatic hydrocarbon group may be any of a linear hydrocarbon group, a branched hydrocarbon group, and a cyclic hydrocarbon group. In addition, the hydrocarbon group may be either a saturated hydrocarbon group or an unsaturated hydrocarbon group. Examples of the hydrocarbon group include a methyl group, an ethyl group, a propyl group, a phenyl group, and the like. The monovalent organic group may itself be an electron-withdrawing group.

When Y² in the above formula (A3) is a group having a conjugate anion of sulfonic acid, examples of Y² include a group represented by the following formula (A4).

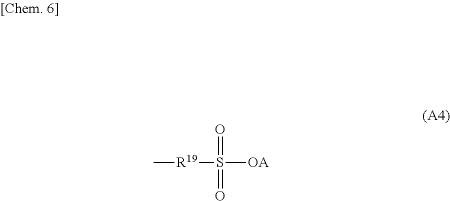

(In formula (A4), R¹⁹ is a covalent bond or a divalent organic group. A is an alkali metal element.)

In the above formula (A4), the number of carbon atoms that the divalent organic group has may be 1 to 20, may be 1 to 15, may be 1 to 10, may be 1 to 5, and may be 1 to 3. Examples of the organic group include divalent substituents such as a hydrocarbon group, a group having a chemical structure formed by substituting one or more carbon atoms (methylene groups) in the hydrocarbon group with a linking group of —O—, —S—, —C(═O)— or —C(═O)O—, and a group having a heterocycle. In addition, the divalent organic group may have a substituent that substitutes a hydrogen atom bonded to a carbon atom. Examples of the substituent include a halogen atom and the like. The hydrocarbon group is not particularly limited, and may be an aliphatic hydrocarbon group or an aromatic hydrocarbon group. The aliphatic hydrocarbon group may be any of a linear hydrocarbon group, a branched hydrocarbon group, and a cyclic hydrocarbon group. In addition, the hydrocarbon group may be either a saturated hydrocarbon group or an unsaturated hydrocarbon group. Examples of the hydrocarbon group include a methylene group, a phenylene group, and the like.

Examples of the group having a conjugate anion of sulfonic acid described above include —SO₃A, —CH₂—SO₃A, —C₆H₄—SO₃A, and the like.

The polymer may include a structural unit (B) represented by the following formula (B). The structural unit (B) is a structural unit other than the structural unit (A) and may not include an alkali-metallized group.

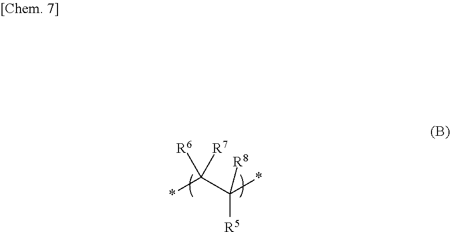

(In formula (B), R⁵ is a hydrogen atom or a monovalent substituent, R⁶ to R⁸ are each independently a hydrogen atom or a monovalent substituent, or one of R⁶ and R⁷ is a hydrogen atom or a monovalent substituent, and the other, together with R⁸, forms a ring. * is a bonding portion of the structural unit (B) with another structural unit.)

When R⁵ in the above formula (B) is a monovalent substituent, it may be a monovalent organic group. The number of carbon atoms that the monovalent organic group has may be 1 to 20, may be 2 to 15, and may be 4 to 10. The monovalent organic group may have one or a plurality of —COOA groups, and may have one —COOA group. Examples of the organic group include a monovalent group such as a hydrocarbon group, a group having a chemical structure formed by substituting one or more carbon atoms (methylene groups) in the hydrocarbon group with a linking group of —O—, —S—, —C(═O)— or —C(═O)O—, and a group having a heterocycle, and the organic group may be a group having an aromatic ring. The aromatic ring may have at least one of a carbon ring and a heterocycle, and may be a carbon ring. An atom that is a ring member of the aromatic ring that R⁵ in the above formula (B) has may be bonded to a carbon atom of the ethylene group in formula (B) (a carbon atom to which R⁵ is directly bonded in formula (B)), and a carbon atom that is a ring member of the aromatic ring that R⁵ has may be bonded to a carbon atom of the ethylene group in formula (B). The group having an aromatic ring may be either a monocyclic system or a condensed ring system, and may be a group having a benzene ring. The group having an aromatic ring may have a monovalent substituent, and the monovalent substituent may be bonded to a carbon atom that is a ring member of the aromatic ring.

Examples of the monovalent substituent bonded to the aromatic ring include a monovalent organic group, an electron-withdrawing group such as a halogen atom (excluding those that are monovalent organic groups), an electron-donating group such as an amino group (—NH₂) (excluding those that are monovalent organic groups), and the like. Examples of the monovalent substituent bonded to the aromatic ring include a substituted or unsubstituted hydrocarbon group, and a group represented by the formula: —R⁴¹—(O—R⁴²)ₙ—OR⁴³. The group represented by the formula: —R⁴¹—(O—R⁴²)ₙ—OR⁴³ may be bonded to the para position of the benzene ring. W¹ may be a divalent group such as —O—, —S—, —C(═O)— or —C(═O)O—, and may be —O—. W² may be a divalent group such as —O—, —S—, —C(═O)— or —C(═O)O—, and may be —O—.

When the monovalent substituent bonded to the aromatic ring is a group represented by the formula: —R⁴¹—(O—R⁴²)ₙ—OR⁴³, R⁴¹ in the group is a covalent bond or a divalent organic group. The divalent organic group may be a divalent hydrocarbon group. The number of carbon atoms that the divalent hydrocarbon group has may be 1 to 8, may be 1 to 5, and may be 1 to 3. A hydrogen atom bonded to the divalent hydrocarbon group may be substituted by a substituent such as a monovalent substituent (that is, it may be a substituted hydrocarbon group). Examples of the substituent include a halogen atom such as a fluorine atom. The divalent hydrocarbon group may be either an aromatic hydrocarbon group or an aliphatic hydrocarbon group, and may be an aliphatic hydrocarbon group. The aliphatic hydrocarbon group may be a saturated aliphatic hydrocarbon group, and may be a linear or branched aliphatic hydrocarbon group. Specific examples of the divalent hydrocarbon group may be a methylene group, an ethylene group, a 1,2-propylene group, a 1,3-propylene group, or a group in which a part or all of the hydrogen atoms thereof are substituted with a halogen atom such as a fluorine atom, and may be a methylene group.

When the monovalent substituent bonded to the aromatic ring is a group represented by the formula: —R⁴¹—(O—R⁴²)ₙ—OR⁴³, R⁴² in the group is a divalent organic group, and may be a divalent hydrocarbon group. The number of carbon atoms that the divalent hydrocarbon group has may be 1 to 8, may be 1 to 5, and may be 1 to 3. A hydrogen atom bonded to the divalent hydrocarbon group may be substituted by a substituent such as a monovalent substituent (that is, the group may be a substituted hydrocarbon group). Examples of the substituent include a halogen atom such as a fluorine atom. The divalent hydrocarbon group may be either an aromatic hydrocarbon group or an aliphatic hydrocarbon group, and may be an aliphatic hydrocarbon group. The aliphatic hydrocarbon group may be a saturated aliphatic hydrocarbon group, and may be a linear or branched aliphatic hydrocarbon group. Specific examples of the divalent hydrocarbon group may be a methylene group, an ethylene group, a 1,2-propylene group, a 1,3-propylene group, or a group in which a part or all of the hydrogen atoms thereof are substituted with a halogen atom such as a fluorine atom, and may be an ethylene group. n in the group represented by the formula: —R⁴¹—(O—R⁴²)ₙ—OR⁴³ may be 1 to 10, may be 1 to 5, and may be 1 to 3. The n may be an integer, or may be a rational number (for example, when n is an average value over the entire structural unit (B) when the polymer has a plurality of structural units (B)). When there are a plurality of R⁴²s in one structural unit, they may be different or the same.

When the monovalent substituent bonded to the aromatic ring is a group represented by the formula: —R⁴¹—(O—R⁴²)ₙ—OR⁴³, R⁴³ in the group may be a hydrogen atom or a divalent hydrocarbon group. The number of carbon atoms that the monovalent hydrocarbon group has may be 1 to 8, may be 1 to 5, and may be 1 to 3. A hydrogen atom bonded to the monovalent hydrocarbon group may be substituted by a substituent such as a monovalent substituent (that is, it may be a substituted hydrocarbon group). Examples of the substituent include a halogen atom such as a fluorine atom. The monovalent hydrocarbon group may be either an aromatic hydrocarbon group or an aliphatic hydrocarbon group, and may be an aliphatic hydrocarbon group. The aliphatic hydrocarbon group may be a saturated aliphatic hydrocarbon group, and may be a linear or branched aliphatic hydrocarbon group. Specific examples of the divalent hydrocarbon group may be a methyl group, an ethyl group, an isopropyl group, an n-propyl group, or a group in which a part or all of the hydrogen atoms thereof are substituted with a halogen atom such as a fluorine atom, and may be a methylene group.

The structural unit (B) may include at least one kind of structural unit derived from a monomer represented by the following formula (B1).

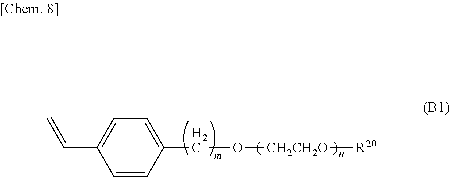

(In the formula, m is 0 to 4, and n is 0 to 10. R²⁰ may be a hydrogen atom or an alkyl group having 1 to 4 carbon atoms. The alkyl group may be a methyl group or an ethyl group, and may be a methyl group.)

In the above formula (B1), m may be 1 to 3, may be 1 to 2, and may be 1. The m may be an integer, or may be an average value over the entire structural unit derived from the monomer represented by formula (B1) included in the polymer (in this case, m is a rational number). In the above formula (B1), n may be 1 to 4, and may be 1 to 3. The n may be an integer, or may be an average value over the entire structural unit derived from the monomer represented by formula (B1) included in the polymer (in this case, n is a rational number).

The number average molecular weight (Mn) of the polymer may be 5,000 to 400,000, may be 8,000 to 200,000, may be 10,000 to 150,000, and may be 10,000 to 100,000. The weight average molecular weight (Mw) of the polymer may be 5,000 to 600,000, may be 10,000 to 400,000, may be 20,000 to 200,000, and may be 20,000 to 100,000. The molecular weight distribution (Mw/Mn) of the polymer may be 1.0 to 5.0, may be 1.2 to 3.0, and may be 1.3 to 2.5.

When the polymer includes the structural unit (A1) and the structural unit (B), the number average molecular weight (Mn) of the polymer may be 5,000 to 200,000, may be 8,000 to 120,000, may be 10,000 to 100,000, and may be 10,000 to 50,000.

The number average molecular weight and weight average molecular weight of the polymer in this specification can be measured by gel permeation chromatography. The gel permeation chromatography (GPC) shall be measured under the conditions shown below. For the creation of a calibration curve, a standard sample of polymethyl methacrylate (manufactured by Polymer Laboratories, Mn of 800 to 2,200,000) shall be used as a standard substance.

### <GPC Measurement Conditions>

Apparatus: GPC-104 (Shodex)
   DU-H2000 precision pump
   74S-RI refractive-index detector
   41-UV UV/vis detector
Column: Shodex LF-404
Temperature: 40° C.
Solvent: Tetrahydrofuran (THF)
Flow rate: 0.3 mL/min
Back pressure: 3.0 MPa
Detection: RI
Sample concentration: 0.5 mass % THF solution
Injection volume: 10 μL

The electrolyte composition may include an anion receptor. The anion receptor refers to a chemical species that captures an anion by forming an electrostatic interaction, a hydrogen bond, an acid-base complex, or the like with the anion. The anion receptor captures a counter anion of an alkali metal ion and promotes dissociation between the counter anion and the alkali metal ion. This increases the mobility of the metal ion. As a result, the conductivity and transference number of alkali metal ions of the electrolyte composition also tend to improve.

Low-molecular-weight chemical species (compounds, etc.) that function as the anion receptor are known, and examples thereof include compounds described in U.S. Pat. Nos. 6,022,643, 5,705,689, 6,120,941, and the like. The anion receptor may have a formula weight (molecular weight) of, for example, 1000 or less, may be 800 or less, and may be 500 or less.

The anion receptor may have Lewis acidity. In this case, the anion receptor can capture an anion by accepting a lone pair of electrons of the anion and forming an acid-base complex. Examples of such a compound include a compound having an electron-deficient atom. An electron-deficient atom refers to an atom that is covalently bonded to another atom but has fewer than eight electrons in its outermost shell. Examples of the electron-deficient atom include atoms belonging to group 13 of the periodic table, and more specifically, the electron-deficient atom may be at least one of an aluminum atom and a boron atom, and may be a boron atom. The anion receptor may be a compound having Lewis acidity and including a group 13 element.

Examples of the anion receptor having a boron atom include boron compounds that function as a Lewis acid, and may be diborane, compounds represented by the following chemical formulas IA to IE, and the like.

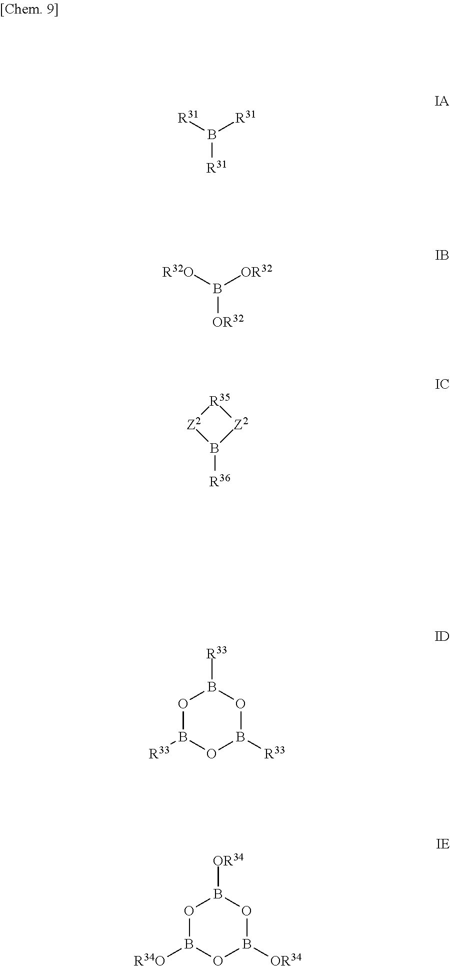

In formula IA, R³¹ is a halogen atom or a monovalent organic group. The halogen atom may be a fluorine atom or a chlorine atom, and may be a fluorine atom. The number of carbon atoms that the monovalent organic group has may be 1 to 20, may be 1 to 15, may be 2 to 10, and may be 2 to 6. The monovalent organic group is not particularly limited, and may be a monovalent group such as a hydrocarbon group, or a group having a chemical structure in which one or more carbon atoms (methylene groups) in a hydrocarbon group are substituted by a linking group of —O—, —S—, —C(═O)— or —C(═O)O—. A hydrogen atom bonded to a hydrocarbon portion in the monovalent organic group may be substituted by a substituent. Here, the monovalent organic group is bonded to the boron atom (B) in formula IA by a carbon atom that the monovalent organic group has. The substituent may be a monovalent substituent such as a halogen atom, may be a monovalent electron-withdrawing group, and may be a fluorine atom. The monovalent organic group may be a hydrocarbon group or a halogen-substituted hydrocarbon group, and the halogen-substituted hydrocarbon group may be a partially or fully fluorinated hydrocarbon group. In one molecule, the plurality of R³¹s may be different from each other or all the same.

In formula IB, R³² is a hydrogen atom or a monovalent organic group. The number of carbon atoms that the monovalent organic group has may be 1 to 20, may be 1 to 15, may be 2 to 10, and may be 2 to 6. The monovalent organic group is not particularly limited, and may be a monovalent group such as a hydrocarbon group, or a group having a chemical structure in which one or more carbon atoms (methylene groups) in a hydrocarbon group are substituted by a linking group of —O—, —S—, —C(═O)— or —C(═O)O—. Here, the monovalent organic group is bonded to the oxygen atom (O) in formula IB by a carbon atom that the monovalent organic group has. A hydrogen atom bonded to a hydrocarbon portion in the monovalent organic group may be substituted by a substituent. The substituent may be a monovalent substituent such as a halogen atom, may be a monovalent electron-withdrawing group, and may be a fluorine atom. The monovalent organic group may be a hydrocarbon group or a halogen-substituted hydrocarbon group, and the halogen-substituted hydrocarbon group may be a partially or fully fluorinated hydrocarbon group. In one molecule, the plurality of R³²s may be different from each other or all the same.

In formula IC, R³⁵ is a divalent organic group, and Z² is a covalent bond or an oxygen atom. The number of carbon atoms that the divalent organic group has may be 1 to 15, may be 2 to 10, and may be 3 to 8. In formula IC, R³⁵, the two Z²s, and the boron atom (B) form a ring, and the number of ring members of the ring may be 4 to 8, and may be 5 or 6. The divalent organic group is not particularly limited, and may be a divalent group such as a hydrocarbon group, or a group having a chemical structure in which one or more carbon atoms (methylene groups) in a hydrocarbon group are substituted by a linking group of —O—, —S—, —C(═O)— or —C(═O)O—. Here, when Z is an oxygen atom, the divalent organic group is bonded to Z² in formula IC by a carbon atom that the divalent organic group has, and when Z² is a covalent bond, the divalent organic group is bonded to the boron atom (B) in formula IC by a carbon atom that the divalent organic group has. A hydrogen atom bonded to a hydrocarbon portion in the divalent organic group may be substituted by a substituent. The substituent may be a monovalent substituent such as a halogen atom, may be a monovalent electron-withdrawing group, and may be a fluorine atom. The divalent organic group may be a hydrocarbon group or a halogen-substituted hydrocarbon group, and the halogen-substituted hydrocarbon group may be a partially or fully fluorinated hydrocarbon group. In one molecule represented by formula IC, the plurality of Z²s may be different from each other or all the same.

In formula IC, R³⁶ is a hydrogen atom or a monovalent organic group. The monovalent organic group may be a group bonded to the boron atom (B) in formula IC by a carbon atom that the monovalent organic group has, but may be a group represented by —OR³⁷. R³⁷ in the group represented by —OR³⁷ is a hydrogen atom or a monovalent organic group. The monovalent organic group as R³⁷ is bonded to the oxygen atom of —OR³⁷ by a carbon atom that the monovalent organic group has. When R³⁶ is a monovalent organic group, the number of carbon atoms that the organic group has may be 1 to 20, may be 1 to 15, may be 2 to 10, and may be 2 to 6. The number of carbon atoms that the monovalent organic group as R³⁷ has may be 1 to 20, may be 1 to 15, may be 2 to 10, and may be 2 to 6. The monovalent organic group is not particularly limited, and may be a monovalent group such as a hydrocarbon group, or a group having a chemical structure in which one or more carbon atoms (methylene groups) in a hydrocarbon group are substituted by a linking group of —O—, —S—, —C(═O)— or —C(═O)O—. A hydrogen atom bonded to a hydrocarbon portion in the monovalent organic group may be substituted by a substituent. Here, the monovalent organic group is bonded to the boron atom (B) in formula IA by a carbon atom that the monovalent organic group has. The substituent may be a monovalent substituent such as a halogen atom, may be a monovalent electron-withdrawing group, and may be a fluorine atom. The monovalent organic group may be a hydrocarbon group or a halogen-substituted hydrocarbon group, and the halogen-substituted hydrocarbon group may be a partially or fully fluorinated hydrocarbon group.

In formula ID, R³³ is a hydrogen atom, a halogen atom, or a monovalent organic group. The halogen atom may be a fluorine atom or a chlorine atom, and may be a fluorine atom. The number of carbon atoms that the monovalent organic group has may be 1 to 20, may be 1 to 15, may be 2 to 10, and may be 2 to 6. The monovalent organic group is not particularly limited, and may be a monovalent group such as a hydrocarbon group, or a group having a chemical structure in which one or more carbon atoms (methylene groups) in a hydrocarbon group are substituted by a linking group of —O—, —S—, —C(═O)— or —C(═O)O—. A hydrogen atom bonded to a hydrocarbon portion in the monovalent organic group may be substituted by a substituent. Here, the monovalent organic group is bonded to the boron atom (B) in formula ID by a carbon atom that the monovalent organic group has. The substituent may be a monovalent substituent such as a halogen atom, may be a monovalent electron-withdrawing group, and may be a fluorine atom. The monovalent organic group may be a hydrocarbon group or a halogen-substituted hydrocarbon group, and the halogen-substituted hydrocarbon group may be a partially or fully fluorinated hydrocarbon group. In one molecule represented by formula ID, the plurality of R³³s may be different from each other or all the same.

In formula IE, R³⁴ is a hydrogen atom or a monovalent organic group. The number of carbon atoms that the monovalent organic group has may be 1 to 20, may be 1 to 15, may be 2 to 10, and may be 2 to 6. The monovalent organic group is not particularly limited, and may be a monovalent group such as a hydrocarbon group, or a group having a chemical structure in which one or more carbon atoms (methylene groups) in a hydrocarbon group are substituted by a linking group of —O—, —S—, —C(═O)— or —C(═O)O—. A hydrogen atom bonded to a hydrocarbon portion in the monovalent organic group may be substituted by a substituent. Here, the monovalent organic group is bonded to the oxygen atom (O) in formula IE by a carbon atom that the monovalent organic group has. The substituent may be a monovalent substituent such as a halogen atom, may be a monovalent electron-withdrawing group, and may be a fluorine atom. The monovalent organic group may be a hydrocarbon group or a halogen-substituted hydrocarbon group, and the halogen-substituted hydrocarbon group may be a partially or fully fluorinated hydrocarbon group. In one molecule represented by formula IE, the plurality of R³⁴s may be different from each other or all the same.

Specific examples of the boron compound include diborane, boron trifluoride, boric acid, boroxine, organic boron compounds such as trimethylborane, triethylborane, tri-n-propylborane, triisopropylborane, triphenylborane, trimethyl borate, triethyl borate, triphenyl borate, tri-n-propyl borate, triisopropyl borate, 2-methoxy-4,4,5,5-tetramethyl-1,3,2-dioxaborolane, 2-ethoxy-4,4,5,5-tetramethyl-1,3,2-dioxaborolane, 2,4,6-trimethylboroxine, 2,4,6-triethylboroxine, 2,4,6-trivinylboroxine, 2,4,6-trimethoxyboroxine, 2,4,6-trimethoxyboroxine, and triphenylboroxine, and halogen-substituted hydrocarbon groups such as tris(2,2,2-trifluoroethyl) borate, 2,4,6-tris(4-fluorophenyl) boroxine, and 2,4,6-tris(3,4,5-trifluorophenyl) boroxine.

Examples of the anion receptor having an aluminum atom include aluminum compounds that function as a Lewis acid, and compounds represented by the formula AlX¹₃ (in the formula, X¹ is a halogen atom and may be a fluorine atom), and the formula: Al(OR³⁵)₃ (in the formula, R³⁵ is a hydrocarbon group and may be an alkyl group).

In addition, the anion receptor may be an azaether. An azaether is a compound in which —O— of an ether compound is replaced with —NR^{E}— (where R^{E} is a hydrogen atom or an organic group). The azaether may be either a chain azaether or a cyclic azaether. The azaether may have an electron-withdrawing group, for example, in a hydrocarbon portion or the like.

The content of the anion receptor in the electrolyte composition may be 10 to 200 parts by mass, may be 30 to 180 parts by mass, may be 50 to 150 parts by mass, and may be 80 to 130 parts by mass, with respect to 100 parts by mass of the polymer having an ability to conduct alkali metal ions.

The electrolyte composition may include an alkali metal salt. Examples of the alkali metal salt include, with M as the alkali metal, MF, MCl, MBr, MI, MClO₄, MPF₆, MBF₄, M₂SO₄, M[(CₕF₂ₕ₊₁)SO₃] (h is 0 to 3), M[(CₕF₂ₕ₊₁)SO₂]₂N (h is 0 to 3), M{[(CₕF₂ₕ₊₁)SO₂]N[(CᵢF₂ᵢ₊₁)SO₂]} (h, i are 0 to 3), and the like. One or more kinds of alkali metal salts may be used. The alkali metal included in the alkali metal salt may be the same alkali metal element as the alkali metal element that the structural unit (A) described in the explanation of the polymer of the present disclosure has.

The content of the alkali metal salt in the electrolyte composition may be 10 to 200 parts by mass, may be 20 to 150 parts by mass, may be 30 to 100 parts by mass, and may be 40 to 75 parts by mass, with respect to 100 parts by mass of the polymer having an ability to conduct alkali metal ions.

The electrolyte composition may further include other resins such as a fluorine-based resin (binder resin, etc.), a fabric such as a non-woven fabric, a porous material, a viscosity modifier, and the like. The electrolyte composition may include, as a fluorine-based resin, a resin having a carbon chain as a main chain. The carbon chain may be one formed by radical polymerization of an ethylenically unsaturated group. Examples of the fluorine resin include poly(vinylidene fluoride-co-hexafluoropropylene) (PVDF-HFP), polyvinylidene fluoride (PVDF), and the like.

The content of the other resin in the electrolyte composition may be 10 to 100 parts by mass, may be 20 to 80 parts by mass, may be 30 to 70 parts by mass, and may be 40 to 60 parts by mass, with respect to 100 parts by mass of the polymer having an ability to conduct alkali metal ions.

The method for producing the electrolyte composition is not particularly limited, but a method of producing it by preparing a dry film of the polymer of the present embodiment or a dry film by mixing the polymer of the present embodiment and a binder resin, and then impregnating the dry film with an organic solvent can be mentioned. When the electrolyte composition includes an alkali metal salt or an anion receptor, an organic solvent may be added after preparing a dry film by mixing the polymer and optionally a binder resin and an alkali metal salt or an anion receptor, or an alkali metal salt or an anion receptor may be dissolved in an organic solvent and added to the dry film.

The electrolyte composition of the present embodiment can be used as a composition for forming an electrolyte for batteries, capacitors, and the like. That is, the electrolyte of the present embodiment includes the above electrolyte composition. Examples of the battery include batteries that perform charging and discharging by the movement of alkali metal ions, such as lithium ion batteries and sodium ion batteries. The battery may be a primary battery or a secondary battery, and may be a solid-state battery.

The battery of the present embodiment includes a positive electrode, a negative electrode, and an electrolyte disposed between the positive electrode and the negative electrode. The positive electrode may be one in which a layer including a positive electrode material is formed on a current collector. In addition, the negative electrode may be one in which a layer including a negative electrode material is formed on a current collector. Hereinafter, a lithium ion battery will be described as an example.

The negative electrode of the lithium ion battery is not particularly limited, and may include a negative electrode active material and, if necessary, a conductive auxiliary agent, a binder, and the like. Examples of the negative electrode active material include simple substances of elements such as Li, Si, P, Sn, Si—Mn, Si—Co, Si—Ni, In, and Au, and alloys or composites including these elements, carbon materials such as graphite, substances in which lithium ions are inserted between layers of the carbon material, and oxides containing titanium.

The positive electrode of the lithium ion battery is not particularly limited, and may include a positive electrode active material and, if necessary, a conductive auxiliary agent, a binder, and the like. Examples of the positive electrode active material include a lithium composite metal oxide including lithium and a transition metal element. The transition metal element may be at least one selected from the group consisting of V, Cr, Mn, Fe, Co, Ni, Cu, and Al, and may include Ni. Examples of the lithium composite metal oxide include LiCoO₂, LiNiO₂, LiMn₂O₄, LiNi_{0.5}Mn_{1.5}O₄, Li₂MnO₃, LiNiₓMn_{y}Co_{1-x-y}O₂ [0<x+y<1]), LiNiₓCo_{y}Al_{1-x-y}O₂ [0<x+y<1]), LiCr_{0.5}Mn_{0.5}O₂, LiFePO₄, Li₂FeP₂O₇, LiMnPO₄, LiFeBO₃, Li₃ V₂(PO₄)₃, Li₂CuO₂, Li₂FeSiO₄, Li₂MnSiO₄, and the like. When the positive electrode active material includes an alkali metal element other than Li, specific examples thereof include those in which Li in the above specific examples is replaced with another alkali metal.

The positive electrode (positive electrode material) of the present embodiment may further include a solid electrolyte material, a binder resin (binder), a conductive auxiliary agent, and the like.

The battery may have a separator. The separator may be a porous material, and may be a resin-made porous material. Specific examples include a porous polyolefin film, a porous ceramic film, and the like.

### EXAMPLES

### Example 1

A lithiated carboxyl group-containing copolymer of Example 1 was produced by the following method.

Saccharin methacrylamide (SacM) (1.8848 g, 7.5 mmol, synthesized product), styrene (St) (0.86 mL, 7.5 mmol), tetralin (0.15 mL), and azobisisobutyronitrile (24.7 mg, 0.15 mmol) were dissolved in a mixed solvent of dioxane and acetonitrile (dioxane:acetonitrile=1:1 (volume ratio)) (12.1 mL), and stirred at 60° C. for 24 hours to obtain a copolymer of saccharin methacrylamide and styrene (starting copolymer).

Next, to the obtained starting copolymer, a 1,4-dioxane solution of 25 mM phenothiazine (45.0 mL, 1.13 mmol) and 100 equivalents of water were added, and the mixture was stirred overnight. As a result, the structural units derived from saccharin methacrylamide in the starting copolymer were hydrolyzed, the amide bond including the saccharin moiety was converted to a —COOH group (that is, the structural unit derived from saccharin methacrylamide was converted to a methacrylic acid (MAA) unit), and a —COOH group-containing copolymer was obtained (0.61 g).

The composition ratio of the structural units in the polymer was MAA:St=48:52 (molar ratio). The composition ratio was calculated by dissolving the polymer in deuterated dimethyl sulfoxide and measuring the ¹H-NMR spectrum. Then, the —COOH group-containing copolymer (0.61 g, 3.21 mmol) was dissolved in dimethylformamide (12 mL) to obtain a solution. To this solution, 2.5 equivalents of LiOH (449.1 mg, 18.82 mmol) with respect to the amount of SacM initially charged when producing the starting copolymer was added, and the mixture was stirred at room temperature (25° C.) for 3 days. As a result, a copolymer in which the —COOH groups of the —COOH group-containing copolymer were converted to —COOLi (lithiated carboxyl group-containing copolymer) was obtained (0.43 g).

The starting copolymer was subjected to alcoholysis with methanol instead of water to synthesize a copolymer of MMA and St, and the molecular weight of the copolymer was measured by gel permeation chromatography. The number average molecular weight of the copolymer was 18,200.

### Example 2

tert-Butyl methacrylate (tBMA) (1.22 mL, 7.5 mmol), styrene (St) (0.86 mL, 7.5 mmol), and azobisisobutyronitrile (20.0 mg, 0.12 mmol) were dissolved in toluene (13.0 mL), and stirred at 60° C. for 24 hours to obtain a copolymer of tert-butyl methacrylate and styrene (starting copolymer) (0.59 g). The composition ratio of the structural units in the starting polymer was tBMA:St=46:54 (molar ratio). The composition ratio was determined by dissolving the starting polymer in deuterated chloroform and measuring the ¹H-NMR spectrum.

Next, to the obtained starting copolymer (0.59 g), an excess of trifluoroacetic acid (15.0 mL, 196 mmol) was added, and the mixture was stirred at 40° C. for 24 hours. As a result, the —C(═O)—O—C(CH₃)₃ groups in the starting copolymer were replaced with —COOH groups (that is, the structural units derived from tBMA were converted to methacrylic acid (MAA) units), and a —COOH group-containing copolymer was obtained (0.36 g).

Then, the —COOH group-containing copolymer (0.36 g) was dissolved in dimethylformamide (3.0 mL) to obtain a solution. To this solution, 2.5 equivalents of LiOH with respect to the amount of tBMA initially charged when producing the starting copolymer was added, and the mixture was stirred at room temperature (25° C.) for 3 days. As a result, a copolymer in which the —COOH groups of the —COOH group-containing copolymer were converted to —COOLi (lithiated carboxyl group-containing copolymer) was obtained (0.26 g). The obtained lithiated carboxyl group-containing copolymer was dissolved in deuterated dimethyl sulfoxide, and the ¹H-NMR spectrum was measured. The composition ratio of the structural units in the lithiated carboxyl group-containing copolymer was lithiated MAA:St=47:53 (molar ratio). The number average molecular weight of the starting copolymer was 18,000.

### (Production of Electrolyte Composition)

Each component was mixed according to the compositions in Tables 1 and 2 to produce each electrolyte composition.

Here, the abbreviations and the like in Tables 1 and 2 are as follows.
TMP: Trimethyl phosphate (DN=23.0)
TEP: Triethyl phosphate (DN=23.4)
EC: Ethylene carbonate (DN=16.4)
PC: Propylene carbonate (DN=15.1)
PVDF-HFP: Vinylidene fluoride-co-hexafluoropropylene

### <Measurement of Ion Conductivity>

The ion conductivity of the electrolyte composition was measured by the method shown below. The ion conductivity at 25° C. (σ₂₅) is shown in Tables 1 and 2.

First, an evaluation cell of a coin-type battery CR2032 was assembled in a glove box under a dry argon atmosphere. Specifically, a test laminate was prepared by laminating each layer in the order of stainless steel plate/electrolyte composition/stainless steel plate in the evaluation cell.

Using an impedance measurement device, measurement is performed at 25° C., a frequency range of 0.1 Hz to 1 MHz, and an applied voltage of 10 mV (vs. open circuit voltage). The ion conductivity σ can be calculated by the following formula. In the following formula, R represents the impedance value, A represents the area of the sample, and t represents the thickness of the sample.

$$σ ( S \cdot {cm}^{- 1} ) = t ( cm ) / R ( Ω ) \times A ( {cm}^{2} ) )$$

### <Activation Energy>

The ion conductivity measurement using the above evaluation cell was also carried out under the conditions of 25° C., 30° C., 40° C., 50° C., 60° C., and 70° C., and the change in ion conductivity with respect to temperature was measured. The activation energy was calculated from the slope of the graph of the common logarithm of the ion conductivity versus the reciprocal of the temperature according to the Arrhenius equation (log k=log A−Ea/RT, k: reaction rate constant, A: frequency factor, Ea: activation energy, R: gas constant, T: absolute temperature). The results are shown in Table 1 and Table 2.

TABLE 1

| | Composition of Electrolyte Composition | | | | | | | |
|---|---|---|---|---|---|---|---|---|
| | | | PVDF- | Organic Solvent | | | | |
| | Copolymer | | HFP | | | Average | σ₂₅ | Ea |
| | Type | Content | Content | Composition | Content | DN | [S/cm] | [kJ/mol] |
| Comparative | Example 1 | 100 | 50 | TEP:EC:PC = 0:50:50 | 300 | 15.8 | 0.08 × 10⁻⁵ | 16.0 |
| Example A1 | | | | | | | | |
| Example A1 | | | | TEP:EC:PC = 15:42.5:42.5 | | 16.9 | 0.25 × 10⁻⁵ | 19.6 |
| Example A2 | | | | TEP:EC:PC = 30:35:35 | | 18.0 | 0.73 × 10⁻⁵ | 19.7 |
| Example A3 | | | | TEP:EC:PC = 50:25:25 | | 19.6 | 2.50 × 10⁻⁵ | 15.2 |
| Example A4 | | | | TEP:EC:PC = 70:15:15 | | 21.1 | 0.53 × 10⁻⁵ | 21.7 |
| Example A5 | | | | TEP:EC:PC = 85:7.5:7.5 | | 22.3 | 0.43 × 10⁻⁵ | 20.5 |
| Example A6 | | | | TEP:EC:PC = 100:0:0 | | 23.4 | 0.57 × 10⁻⁵ | 23.1 |

*The content of each component and the composition of the mixed solvent are all by mass ratio.

TABLE 2

| | Composition of Electrolyte Composition | | | | | | | |
|---|---|---|---|---|---|---|---|---|
| | | | PVDF- | Organic Solvent | | | | |
| Electrolyte | Copolymer | | HFP | | | Average | σ₂₅ | Ea |
| Composition | Type | Content | Content | Composition | Content | DN | [S/cm] | [kJ/mol] |
| Comparative | Example 1 | 100 | 50 | TEP:EC:PC = 0:50:50 | 300 | 15.8 | 0.08 × 10⁻⁵ | 16.0 |
| Example A1 | | | | | | | | |
| Example A7 | | | | TMP:EC:PC = 50:25:25 | | 19.4 | 0.84 × 10⁻⁵ | 18.1 |
| Example A6 | | | | TEP:EC:PC = 100:0:0 | | 19.6 | 0.57 × 10⁻⁵ | 23.1 |
| Example A3 | | | | TEP:EC:PC = 50:25:25 | | 23.4 | 2.50 × 10⁻⁵ | 15.2 |
| Example A8 | Example 2 | | | TEP:EC:PC = 50:25:25 | | 23.4 | 0.72 × 10⁻⁵ | 19.6 |

*The content of each component and the composition of the mixed solvent are all by mass ratio.

### (Production of Electrolyte Composition)

Each component was mixed according to the compositions in Table 3 and Table 4 to produce each electrolyte composition including an anion receptor, and the ion conductivity at 25° C. and the activation energy were determined by the method described above.

Here, the abbreviations and the like in Table 3 and Table 4 are as follows. As the lithium salt in Table 4, lithium (bis-trifluoromethanesulfonyl)imide (LiTFSI) was used.
MTD: 2-methoxy-4,4,5,5-tetramethyl-1,3,2-dioxaborolane
TEB: tris(2,2,2-trifluoroethyl) borate
TFB: 2,4,6-tris(4-fluorophenyl)boroxine
PVDF-HFP: vinylidene fluoride-co-hexafluoropropylene

TABLE 3

| | Composition of Electrolyte Composition | | | | | | | | | |
|---|---|---|---|---|---|---|---|---|---|---|
| | | | PVDF- | Anion | | Organic Solvent | | | | |
| Electrolyte | Copolymer | | HFP | Receptor | | | | Average | σ₂₅ | Ea |
| Composition | Type | Content | Content | Type | Content | Composition | Content | DN | [S/cm] | [kJ/mol] |
| Comparative | Example 1 | 100 | 50 | — | 0 | EC:PC = 50:50 | 300 | 15.8 | 7.6 × 10⁻⁷ | 16.0 |
| Example A1 | | | | | | | | | | |
| Example A3 | | | | | | TEP:EC:PC = 50:25:25 | | 19.6 | 2.5 × 10⁻⁵ | 15.2 |
| Comparative | | | | TEB | 100 | EC:PC = 50:50 | | 15.8 | 7.6 × 10⁻⁶ | 16.6 |
| Example B1 | | | | | | | | | | |
| Example B1 | | | | | | TEP:EC:PC = 50:25:25 | | 19.6 | 2.6 × 10⁻⁵ | 19.2 |
| Example B2 | | | | TFB | 100 | TEP:EC:PC = 50:25:25 | | 19.6 | 6.1 × 10⁻⁵ | 22.3 |

*The content of each component and the composition of the mixed solvent are all by mass ratio.

TABLE 4

| | Composition of Electrolyte Composition | | | | | | | | | | |
|---|---|---|---|---|---|---|---|---|---|---|---|
| | | | PVDF- | Anion | | Organic Solvent | | | Lithium | | |
| Electrolyte | Copolymer | | HFP | Receptor | | | | Average | Salt | σ₂₅ | Ea |
| Composition | Type | Content | Content | Type | Content | Composition | Content | DN | Content | [S/cm] | [kJ/mol] |
| Example B3 | Example 1 | 100 | 50 | MTD | 100 | TEP:EC:PC = 50:25:25 | 450 | 19.6 | 50 | 3.6 × 10⁻⁴ | 15.9 |
| Example B4 | | | | TEB | | | | | | 4.5 × 10⁻⁴ | 16.3 |
| Example B5 | | | | TFB | | | | | | 1.4 × 10⁻³ | 14.2 |

*The content of each component and the composition of the mixed solvent are all by mass ratio.

### Example 3

A lithiated carboxyl group-containing copolymer of Example 2 was produced by the following method.

In the following Examples 3 to 5, a monomer represented by the following formula (that is, 4-(2-methoxyethoxy)methoxystyrene) was used instead of styrene in Example 1.

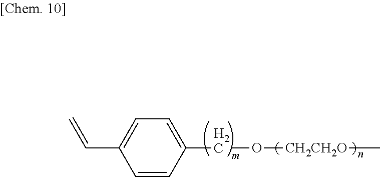

(Here, m=1 and n=1. Hereinafter, the compound represented by the above formula is also described as St_{m n}.)

Saccharin methacrylamide (SacM) (628.8 mg, 2.5 mmol), St_{1 1} (0.49 mL, 2.5 mmol), azobisisobutyronitrile (8.8 mg, 0.05 mmol), and (tetralin (0.05 mL)) were dissolved in a mixed solvent of dioxane and acetonitrile (dioxane:acetonitrile=1:1 (volume ratio)) (3.75 mL), and stirred at 60° C. for 24 hours to obtain a copolymer of SacM and St_{1 1} (starting copolymer).

Next, to the obtained starting copolymer, a 1,4-dioxane solution of 25 mM phenothiazine (15.0 mL, 0.38 mmol) and 100 equivalents of water were added, and the mixture was stirred overnight. As a result, the structural units derived from saccharin methacrylamide in the starting copolymer were hydrolyzed, the amide bond including the saccharin moiety was converted to a —COOH group (that is, the structural unit derived from saccharin methacrylamide was converted to a methacrylic acid (MAA) unit), and a —COOH group-containing copolymer was obtained (0.28 g).

The composition ratio of the structural units in the polymer was MAA:St_{1 1}=47:53 (molar ratio). The composition ratio was calculated by dissolving the polymer in deuterated dimethyl sulfoxide and measuring the ¹H-NMR spectrum.

Then, the —COOH group-containing copolymer (0.28 g, 1.00 mmol) was dissolved in dimethylformamide (4.6 mL) to obtain a solution. To this solution, 2.5 equivalents of LiOH (149.0 mg, 6.22 mmol) with respect to the amount of SacM initially charged when producing the starting copolymer was added, and the mixture was stirred at room temperature (25° C.) for 3 days (24 hours). As a result, a copolymer in which the —COOH groups of the —COOH group-containing copolymer were converted to —COOLi (lithiated carboxyl group-containing copolymer) was obtained (0.23 g). In the synthesized copolymer, since the —COO⁻ group, which is the counter anion of the lithium ion, is fixed on the copolymer, it is not transported even when a voltage is applied, and the lithium ion transference number was sufficiently high.

The starting copolymer was subjected to alcoholysis with methanol instead of water to synthesize a copolymer of MMA and St, and the molecular weight of the copolymer was measured by gel permeation chromatography. The number average molecular weight of the copolymer was 30,100.

### Example 4

Saccharin methacrylamide (SacM) (628.7 mg, 2.5 mmol), St_{1 2} (0.58 mL, 2.5 mmol), azobisisobutyronitrile (8.6 mg, 0.05 mmol), and tetralin (0.05 mL)) were dissolved in a mixed solvent of dioxane and acetonitrile (dioxane:acetonitrile=1:1 (volume ratio)) (3.75 mL), and stirred at 60° C. for 24 hours to obtain a copolymer of SacM and St_{1 2} (starting copolymer).

Next, to the obtained starting copolymer, a 1,4-dioxane solution of 25 mM phenothiazine (15.0 mL, 0.38 mmol) and 100 equivalents of water were added, and the mixture was stirred overnight. As a result, the structural units derived from saccharin methacrylamide in the starting copolymer were hydrolyzed, the amide bond including the saccharin moiety was converted to a —COOH group (that is, the structural unit derived from saccharin methacrylamide was converted to a methacrylic acid (MAA) unit), and a —COOH group-containing copolymer was obtained (0.33 g).

The composition ratio of the structural units in the polymer was MAA:St_{1 2}=48:52 (molar ratio). The composition ratio was calculated by dissolving the polymer in deuterated dimethyl sulfoxide and measuring the ¹H-NMR spectrum.

Then, the —COOH group-containing copolymer (0.33 g, 1.02 mmol) was dissolved in dimethylformamide (6.0 mL) to obtain a solution. To this solution, 2.5 equivalents of LiOH (147.9 g, 6.25 mmol) with respect to the amount of SacM initially charged when producing the starting copolymer was added, and the mixture was stirred at room temperature (25° C.) for 3 days (24 hours). As a result, a copolymer in which the —COOH groups of the —COOH group-containing copolymer were converted to —COOLi (lithiated carboxyl group-containing copolymer) was obtained (0.29 g). In the synthesized copolymer, since the —COO group, which is the counter anion of the lithium ion, is fixed on the copolymer, it is not transported even when a voltage is applied, and the lithium ion transference number was sufficiently high.

The starting copolymer was subjected to alcoholysis with methanol instead of water to synthesize a copolymer of MMA and St, and the molecular weight of the copolymer was measured by gel permeation chromatography. The number average molecular weight of the copolymer was 30,100.

### Example 5

Saccharin methacrylamide (SacM) (0.6284 g, 2.5 mmol), St_{1 3} (0.68 g, 2.5 mmol), azobisisobutyronitrile (8.9 mg, 0.05 mmol), and tetralin (0.05 mL) were dissolved in a mixed solvent of dioxane and acetonitrile (dioxane:acetonitrile=1:1 (volume ratio)) (3.70 mL), and stirred at 60° C. for 24 hours to obtain a copolymer of SacM and St_{1 3} (starting copolymer).

Next, to the obtained starting copolymer, a 1,4-dioxane solution of 25 mM phenothiazine (15.0 mL, 0.38 mmol) and 100 equivalents of water were added, and the mixture was stirred overnight. As a result, the structural units derived from saccharin methacrylamide in the starting copolymer were hydrolyzed, the amide bond including the saccharin moiety was converted to a —COOH group (that is, the structural unit derived from saccharin methacrylamide was converted to a methacrylic acid (MAA) unit), and a —COOH group-containing copolymer was obtained (0.60 g).

The composition ratio of the structural units in the polymer was MAA:St_{1 3}=49:51 (molar ratio). The composition ratio was calculated by dissolving the polymer in deuterated dimethyl sulfoxide and measuring the ¹H-NMR spectrum.

Then, the —COOH group-containing copolymer (0.49 g, 1.34 mmol) was dissolved in dimethylformamide (10.0 mL) to obtain a solution. To this solution, 2.5 equivalents of LiOH (150.2 mg, 6.27 mmol) with respect to the amount of SacM initially charged when producing the starting copolymer was added, and the mixture was stirred at room temperature (25° C.) for 3 days (24 hours). As a result, a copolymer in which the —COOH groups of the —COOH group-containing copolymer were converted to —COOLi (lithiated carboxyl group-containing copolymer) was obtained (0.43 g). In the synthesized copolymer, since the —COO group, which is the counter anion of the lithium ion, is fixed on the copolymer, it is not transported even when a voltage is applied, and the lithium ion transference number was sufficiently high.

The starting copolymer was subjected to alcoholysis with methanol instead of water to synthesize a copolymer of MMA and St, and the molecular weight of the copolymer was measured by gel permeation chromatography. The number average molecular weight of the copolymer was 32,000.

Each component was mixed according to the composition in Table 5 to produce each electrolyte composition, and the ion conductivity at 25° C. and the activation energy were determined by the method described above.

TABLE 5

| | Composition of Electrolyte Composition | | | | | | | |
|---|---|---|---|---|---|---|---|---|
| | | | PVDF- | Organic Solvent | | | | |
| Electrolyte | Copolymer | | HFP | | | Average | σ₂₅ | Ea |
| Composition | Type | Content | Content | Composition | Content | DN | [S/cm] | [kJ/mol] |
| Example A9 | Example 3 | 100 | 50 | TEP:EC:PC = 50:25:25 | 300 | 19.6 | 2.7 × 10⁻⁵ | 14.9 |
| Example A10 | Example 4 | | | | | | 2.5 × 10⁻⁵ | 14.0 |
| Example A11 | Example 5 | | | | | | 3.0 × 10⁻⁵ | 14.9 |
| Comparative | Example 3 | | | EC:PC = 25:25 | | 15.8 | 0.14 × 10⁻⁵ | 25.9 |
| Example A9 | | | | | | | | |
| Comparative | Example 4 | | | | | | 0.21 × 10⁻⁵ | 23.8 |
| Example A10 | | | | | | | | |
| Comparative | Example 5 | | | | | | 0.17 × 10⁻⁵ | 24.3 |
| Example A11 | | | | | | | | |

*The content of each component and the composition of the mixed solvent are all by mass ratio.

### Example 6

A copolymer of monomer A1 represented by the following formula and styrene was produced as follows.

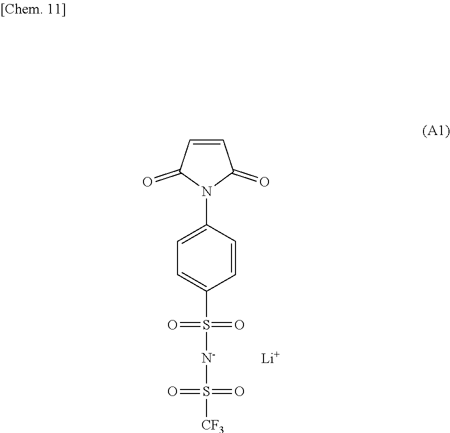 [SMILES: O=C1C=CC(=O)N1c1ccc(S(=O)(=O)[N-]S(=O)(=O)C(F)(F)F)cc1 ; [Li+]]

First, monomer A1 was produced as follows.

### (Synthesis of Monomer A1)

Under a nitrogen atmosphere, trifluoromethanesulfonamide (52.5 mmol, 7.83 g, manufactured by Tokyo Chemical Industry Co., Ltd.) was dissolved in dehydrated acetonitrile (150 mL, manufactured by Kanto Chemical Co., Inc.). To this solution, lithium hydroxide (105 mmol, 2.51 g, manufactured by Tokyo Chemical Industry Co., Ltd.) and 4-acetamidobenzenesulfonyl chloride (50 mmol, 11.68 g, manufactured by Tokyo Chemical Industry Co., Ltd.) were added in order and heated under reflux for 5 hours. After cooling to room temperature, an excess amount of acetonitrile (700 mL) was added to precipitate a solid, which was separated by filtration and then washed with dichloromethane (manufactured by Kanto Chemical Co., Inc.) to obtain intermediate 1. The yield was 97.1%.

### Structural Formula of Intermediate 1:

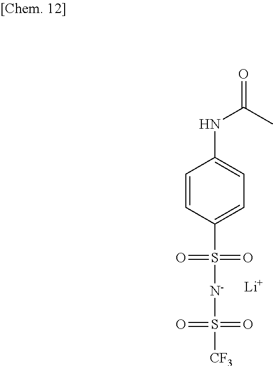 [SMILES: CC(=O)Nc1ccc(S(=O)(=O)[N-]S(=O)(=O)C(F)(F)F)cc1 ; [Li+]]

Under a nitrogen atmosphere, 5% hydrochloric acid (22.5 mL) was added to intermediate 1 (15 mmol, 5.28 g), and the mixture was stirred at 90° C. for 2 hours. After cooling to room temperature, an aqueous solution of lithium hydroxide was added until the pH became 7 or more while checking with pH test paper, and then a solid was obtained by drying under reduced pressure. The obtained solid was extracted with an acetonitrile solution and dried under reduced pressure to obtain intermediate 2. The yield was 92.6% based on the raw material of the intermediate 1.

### Structural Formula of Intermediate 2:

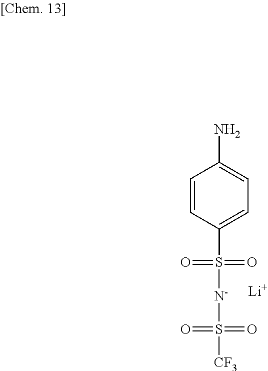 [SMILES: Nc1ccc(S(=O)(=O)[N-]S(=O)(=O)C(F)(F)F)cc1 ; [Li+]]

Under a nitrogen atmosphere, maleic anhydride (13.3 mmol, 1.30 g, manufactured by Tokyo Chemical Industry Co., Ltd.) was dissolved in dehydrated 1,4-dioxane (manufactured by Kanto Chemical Co., Inc.). To this solution, a solution of intermediate 2 (13.2 mmol, 4.09 g) in dehydrated tetrahydrofuran (26.4 mL, manufactured by Kanto Chemical Co., Inc.), prepared under a nitrogen atmosphere, was added dropwise in its entirety, and the mixture was stirred at room temperature for 12 hours. After the reaction, the precipitate was filtered and vacuum dried at 60° C. for 4 hours to obtain a solid including intermediate 3.

### Structural Formula of Intermediate 3:

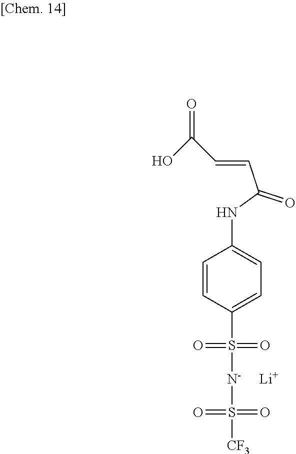 [SMILES: O=C(O)/C=C/C(=O)Nc1ccc(S(=O)(=O)[N-]S(=O)(=O)C(F)(F)F)cc1 ; [Li+]]

Under a nitrogen atmosphere, the solid including intermediate 3 (14.0 mmol, 5.70 g) and lithium acetate (13.3 mmol, 1.09 g, manufactured by Tokyo Chemical Industry Co., Ltd.) were added to acetic anhydride (12.3 mL, manufactured by Tokyo Chemical Industry Co., Ltd.), and the mixture was stirred at 70° C. for 3 hours. The entire reaction solution was added dropwise to an excess amount of diethyl ether (manufactured by Kanto Chemical Co., Inc.) at 0° C., and the precipitate was collected by filtration. Under an inert atmosphere, the precipitate was extracted with dehydrated acetonitrile (manufactured by Kanto Chemical Co., Inc.) and dried under reduced pressure to obtain monomer A1. The overall yield through all steps was 72.8%.

Monomer A1:0.558 g, styrene: 0.149 g, and azobisisobutyronitrile: 11.7 mg were dissolved in 6.7 mL of dehydrated acetonitrile, and the reaction was carried out at 60° C. for 24 hours under a nitrogen atmosphere while confirming the monomer consumption rate by adding tetralin as an internal standard substance. The polymerization solution was dialyzed in acetonitrile and vacuum dried at 120° C. to obtain 0.640 g (yield 87%) of a copolymer (copolymer of Example A1). The monomer incorporation ratio was monomer of Example A1:styrene=52:48. The monomer incorporation ratio was calculated from ¹H-NMR of the copolymer.

The copolymer had a number average molecular weight Mn=9.4×10⁴, a weight average molecular weight Mw=4.2×10⁵, and a molecular weight distribution Mw/Mn=4.45. The number average molecular weight and weight average molecular weight were measured by gel permeation chromatography. As for styrene, a commercially available reagent with a purity>98% from Aldrich was sealed with CaCl₂) and dried overnight, and CaH₂ was added, followed by vacuum distillation to improve the purity before use.

Each component was mixed according to the composition in Table 6 to produce each electrolyte composition, and the ion conductivity at 25° C., activation energy, and transference number were determined by the method described above.

TABLE 6

| | Composition of Electrolyte Composition | | | | | | | |
|---|---|---|---|---|---|---|---|---|
| | | | PVDF- | Organic Solvent | | | | |
| Electrolyte | Copolymer | | HFP | | | Average | σ₂₅ | Ea |
| Composition | Type | Content | Content | Composition | Content | DN | [S/cm] | [kJ/mol] |
| Comparative | Example 6 | 100 | 50 | EC:PC = 50:50 | 300 | 15.8 | 3.75 × 10⁻⁴ | 14.3 |
| Example AA1 | | | | | | | | |
| Example AA1 | | | | TEP:EC:PC = 70:15:15 | | 21.1 | 6.09 × 10⁻⁴ | 15.2 |
| Example AA2 | | | | TEP:EC:PC = 50:25:25 | | 19.6 | 5.07 × 10⁻⁴ | 17.8 |

*The content of each component and the composition of the mixed solvent are all by mass ratio.

### <Measurement of Lithium Ion Transference Number>

The lithium ion transference number of the electrolyte composition produced as described above was measured by the following method. The results are shown in Table 7.

An evaluation cell of a coin-type lithium battery CR2032 was assembled in a glove box under a dry argon atmosphere. Specifically, a test laminate was prepared by laminating each layer in the order of lithium/electrolyte composition/lithium in the evaluation cell.

The method for measuring the lithium ion transference number is the one introduced in Polymer, 28, 2324 (1987). That is, at room temperature (25° C.), 10 mV was applied to the test laminate, the initial current value (I₀) and the steady current value (Iₛₛ) were measured, and further, the interface resistance measurement value R₀ before voltage application and the interface resistance measurement value R_{SS} after voltage application were determined by the complex impedance method. Then, the obtained values were introduced into the following formula to determine the lithium ion transference number (t_{Li+}). In the formula, V is the applied voltage.

$${t}_{L i +} = {I}_{s s} ( V - {I}_{0} {R}_{0} ) / {I}_{0} ( V - {I}_{S S} {R}_{S S} )$$

TABLE 7

| Electrolyte composition | Li⁺ transference number |
|---|---|
| Example B5 | 0.85 |
| Example A3 | 0.81 |
| Example A9 | 0.94 |
| Example A10 | 0.93 |
| Example A11 | 0.93 |
| Example AA1 | 0.73 |
| Example AA1 | 0.86 |

1. An electrolyte composition comprising a polymer having an ability to conduct alkali metal ions and an organic solvent, wherein
an overall donor number represented by the following formula (I) of the organic solvent contained in the electrolyte composition is 16.5 or more:
$$\begin{matrix}[ Formula 1 ] & \\ DN = {\sum }_{i = 1}^{n} ( DNi ) \times ( fi ) & ( 1 )\end{matrix}$$
(wherein n is a total number of organic solvents contained in the electrolyte composition and is 1 or more, DNi is a donor number of an i-th organic solvent, and fi is a mass fraction of the i-th organic solvent).

2. An electrolyte composition comprising a polymer having an ability to conduct alkali metal ions and an organic solvent, wherein
a proportion of an organic solvent having a donor number of 17 or more among the organic solvent contained in the electrolyte composition is 10 mass % or more based on a total amount of the organic solvent.

3. The electrolyte composition according to claim 1, wherein the organic solvent comprises one or more organic solvents selected from the group consisting of ether-based solvents, phosphate ester-based solvents, carbonate-based solvents, fluorine-based solvents, and nitrile-based solvents.

4. The electrolyte composition according to claim 1, further comprising an anion receptor.

5. The electrolyte composition according to claim 4, wherein the anion receptor is a compound having Lewis acidity and containing a group 13 element.

6. The electrolyte composition according to claim 1, further comprising an alkali metal salt.

7. The electrolyte composition according to claim 1, wherein the polymer having an ability to conduct alkali metal ions comprises one or more groups selected from the group consisting of alkali-metallized sulfonylimide groups, alkali-metallized sulfonic acid groups, alkali-metallized carboxylic acid groups, and alkali-metallized phenol groups.

8. A battery comprising the electrolyte composition according to claim 1.
